(19) United States
(12) Patent Application Publication
(10) Pub. No.: US 2011/0139013 A1
(43) Pub. Date: Jun. 16, 2011

(54) Bolt Retainer For Popcorn Popping Kettles

(75) Inventor: Ronald R. Weiss, Okeana, OH (US)

(73) Assignee: GOLD MEDAL PRODUCTS COMPANY, Cincinnati, OH (US)

(21) Appl. No.: 12/637,297

(22) Filed: Dec. 14, 2009

(51) Int. Cl. A23L 1/18; B23P 19/04; F16B 39/34

(52) U.S. Cl. 99/323.9; 29/700; 411/313

(57) ABSTRACT

A bolt retainer for mounting a bolt having a head portion and a shank portion to a bottom wall of a kettle includes a pair of spaced apart side walls, a bottom wall extending between the pair of side walls and a notch formed in the bottom wall. The pair of spaced apart side walls and the bottom wall define a cavity that is configured to receive the head portion of the bolt therein with the shank portion of the bolt extending through the notch in a direction away from the bottom wall of the kettle.

### FIELD OF THE INVENTION

The present invention relates generally to cooking appliances and, more particularly, to a kettle for use in a popcorn popping machine.

### BACKGROUND OF THE INVENTION

Popcorn is often mass-produced for sale at movies and other events in commercial popcorn poppers which generally include an enclosed, transparent cabinet containing a tiltable kettle suspended above a catch area or platform. The kettle is heated and uncooked popcorn kernels are placed therein to be cooked and popped. Oil, salt and other flavorings might also be added to the kettle for flavoring the popcorn in the popping process. Once the kernels are popped, the kettle is tilted, either manually or automatically, and the popcorn spills onto the platform to be scooped up, packaged and sold to customers. More recently, and especially as home movie theaters have gained in popularity, popcorn poppers have begun to move into the residential market for residential consumption as well. In the residential market, the residential popcorn poppers are often used to make smaller batches of popcorn than those made in commercial environments.

Conventional kettles require that fasteners be welded to the bottom thereof to mount a heating element thereupon. For example, FIG. 1 illustrates a prior art kettle 10 having an upstanding side wall 12 and a bottom wall 14. A plurality of machined, threaded fasteners 16 are welded to the bottom wall 14 of the kettle 10 so that a threaded shaft or shank of each fastener 14 extends downwardly from the bottom wall 14 of the kettle 10. Each fastener 16 is machined such that its head is reduced in size and has at least four sides, with the head of each fastener being welded to the kettle bottom.

During welding of the fasteners 16 to the kettle 10, a number of defects may occur because of the small surface area with which to attach the fasteners 16 to the bottom 14 of the kettle 10. Specifically, an undercut defect often occurs, which often removes a portion of the machined portion of the fastener 16 and creates a stress area in the form of a notch, which can often amplify stress concentration. A notch in a fastener 16 may eventually widen and/or otherwise continue through the fastener 16 and cause at least a portion of that fastener 16 to fall off.

When a fastener 16 falls off, there may be a loss in structural integrity of anything held thereby, including a heating element (not shown in FIG. 1) secured to the kettle bottom by the fasteners 16. Moreover, a short circuit in the kettle heater may occur when a fastener 16 falls off, as that fastener may short across the heating element, and/or wires connected to the heating element. A fastener 16 that has fallen off the bottom 14 of the kettle 10 can increase popcorn cooking times and/or decrease the efficiency of a cooking cycle. Furthermore, it is often expensive and time consuming to fix a kettle 10 after a fastener 16 has fallen off, as the kettle 10 must be machined down to a uniform surface at the location of the missing fastener, the kettle 10 must then be stripped of all chrome, a new fastener 16 must be welded to the kettle bottom, and then the kettle must be re-chromed. This process often takes a number of days or even weeks and may be associated with a substantial cost due to repairs, loss of income, and lost opportunities, as a popcorn popper with no kettle is typically useless.

Therefore, there is a need for an improved popcorn popping kettle having bolts mounted to the bottom wall of the kettle for mounting one or more heating elements to the bottom wall of the kettle.

### SUMMARY OF THE INVENTION

The present invention overcomes the foregoing and other shortcomings and drawbacks of popcorn popping kettle assemblies heretofore known for use in a popcorn popping machine. While the invention will be described in connection with certain embodiments, it will be understood that the invention is not limited to these embodiments. On the contrary, the invention includes all alternatives, modifications and equivalents as may be included within the spirit and scope of the present invention.

According to one aspect of the present invention, a bolt retainer is provided for use in mounting a bolt having a head portion and a shank portion to a bottom wall of a popcorn popping kettle. The bolt retainer includes a pair of spaced apart side walls that are configured to be mounted to the bottom wall of the popcorn popping kettle. A bottom wall of the bolt retainer extends between the pair of spaced apart side walls and has a notch formed in the bottom wall. The pair of spaced apart side walls and the bottom wall define a cavity that is configured to receive the head portion of the bolt therein with the shank portion of the bolt extending through the notch in a direction away from the bottom wall of the kettle. According to these, at least one heating element may be mounted to the bottom wall of the kettle using the bolts.

According to another aspect of the present invention, a popcorn popping kettle assembly is provided including a popcorn popping kettle having an upstanding side wall and a bottom wall and a plurality of bolt retainers mounted to the bottom wall of the kettle. A plurality of bolts, each having a head portion and a shank portion, are slidably coupled with and supported by a respective one of the bolt retainers with the shank portions of the bolts extending in a direction away from the bottom wall of the kettle so that a heating element may be mounted to the bottom wall of the kettle using the bolts.

According to another aspect of the present invention, a method of mounting a bolt having a head portion and a shank portion to a bottom wall of the popcorn popping kettle is disclosed. The method comprises the steps of mounting a bolt retainer to the bottom wall of the kettle and slidably coupling the bolt with the bolt retainer so that the bolt is supported by the bolt retainer with the shank portion of the bolt extending in a direction away from the bottom wall of the kettle.

According to yet another aspect of the present invention, a method of assembling a popcorn popping kettle is disclosed comprising the steps of obtaining a popcorn popping kettle having an upstanding side wall and a bottom wall, mounting a plurality of bolt retainers to the bottom wall of the kettle, and slidably coupling a plurality of bolts each having a head portion and a shank portion with a respective one of the plurality of bolt retainers so that the plurality of bolts are supported by the plurality of bolt retainers with a shank portion of each bolt extending in a direction away from the bottom wall of the kettle.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is a perspective view of a conventional popcorn popping kettle;

FIG. 2 is a disassembled perspective view of a kettle upon which is mounted a plurality of outer bolt retainers and a plurality of inner bolt retainers according to one embodiment of the present invention;

FIG. 3A is a bottom perspective view of an outer bolt retainer according to one embodiment of the present invention;

FIG. 3B is a top view of the outer bolt retainer of FIG. 3A;

FIG. 3C is a side view of the outer bolt retainer of FIG. 3A;

FIG. 4A is a bottom perspective view of an inner bolt retainer according to one embodiment of the present invention;

FIG. 4B is a top view of the inner bolt retainer of FIG. 4A;

FIG. 4C is a side view of the inner bolt retainer of FIG. 4A;

FIG. 5A is a diagrammatic, partial cutaway view along line 5A-5A of FIG. 2 (when parts are fully assembled) that illustrates the interconnection of the inner bolt retainer and other components mounted upon the kettle;

FIG. 5B is a diagrammatic, partial cutaway view along line 5B-5B of FIG. 2 (when parts are fully assembled) that illustrates the interconnection of the inner bolt retainer and other components mounted upon the kettle;

FIG. 6A is a diagrammatic, partial cutaway view along line 6A-6A of FIG. 2 (when parts are fully assembled) that illustrates the interconnection of the outer bolt retainer and other components mounted upon the kettle;

FIG. 6B is a diagrammatic, partial cutaway view along line 6B-6B of FIG. 2 (when parts are fully assembled) that illustrates the interconnection of the outer bolt retainer and other components mounted upon the kettle;

FIG. 7A is a disassembled perspective view of a nut retainer that may be used to retain a nut on a bolt according to one embodiment of the present invention; and

FIG. 7B is a partially assembled perspective view of the nut retainer of FIG. 7A retaining the nut.

It should be understood that the appended drawings are not necessarily to scale, presenting a somewhat simplified representation of various preferred features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments may have been enlarged or distorted relative to others to facilitate visualization and clear understanding.

### DETAILED DESCRIPTION OF THE INVENTION

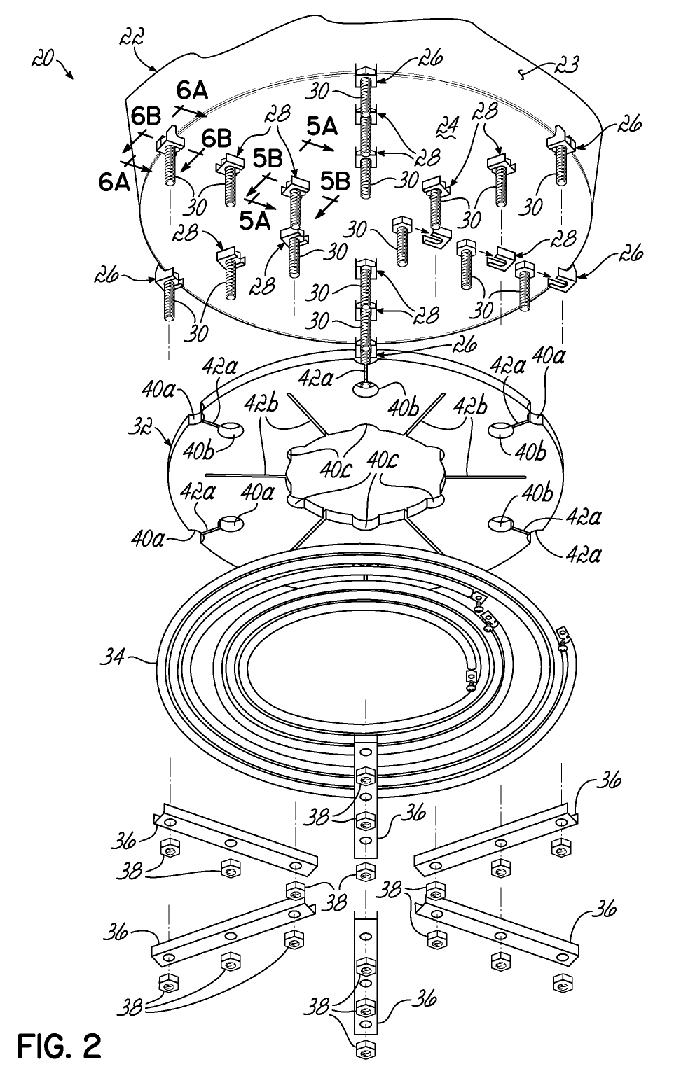

Referring now to the figures, FIG. 2 illustrates a kettle assembly 20 according to one embodiment of the present invention including a popcorn popping kettle 22 having an upstanding side wall 23 and a bottom wall 24 upon which is mounted a plurality of outer bolt retainers 26 and a plurality of inner bolt retainers 28. As will be described in greater detail below, each bolt retainer 26 and/or 28 is configured to receive and retain a threaded fastener, such as bolt 30 so that the bolts 30 extend downwardly from the bottom wall 24 of the kettle 22 as shown. As illustrated in FIG. 2, the plurality of outer bolt retainers 26 and the plurality of inner bolt retainers 28 may be mounted circumferentially about the center of the kettle 22 in rows radiating therefrom, with each row comprising an outer bolt retainer 26 and at least one inner bolt retainer 28. Each of the bolt retainers 26 and/or 28 is welded or otherwise suitably fastened to the bottom wall 24 of the kettle 22.

The bolts 30 may be configured to secure a heat transfer plate 32 and at least one heating element 34 to the kettle 22. In some embodiments, the heat transfer plate 32 is configured to provide improved heat transfer to the bottom wall 24 of the kettle 22 than may be possible using the heating element 34 alone. Specifically, the heat transfer plate 32 may be configured to spread the heat from the heating element 34 across a larger surface area of the bottom wall 24 of the kettle 22 than would be possible with the heating element 34 alone. The heat transfer plate 32 and heating element 34 may be secured to the kettle 22 through at least one retaining bar 36 that is, in turn, retained on the bolts 30 by a plurality of nuts 38. In one embodiment, a single retaining bar 36 is configured for each row of bolts 30. Of course, other retaining structures are possible as well without departing from the spirit and scope of the present invention.

The heat transfer plate 32 may be configured with a plurality of voids 40a-c (e.g., either partial or full voids) corresponding to locations on the bottom wall 24 of the kettle 22 for each of the plurality of bolt retainers 26 and/or 28 such that the heat transfer plate 32 is configured to contact the bottom wall 24 of the kettle 22 without contacting a bolt retainer 26 and/or 28. Moreover, the heat transfer plate 32 may be configured with one or more expansion areas 42a-b to allow for expansion of the heat transfer plate 32 as it is heated by the heating element 34. Thus, each bolt retainer 26 and/or 28 may be welded to the bottom wall 24 of a kettle 22 to receive a bolt 30 that is in turn adaptable to secure a heating element 34 to the kettle 22 for heating contents thereof (e.g., popcorn, oil, flavoring and/or salt).

FIG. 3A is a bottom perspective view of an outer bolt retainer 26 according to one embodiment that is configured to receive a bolt 30 and attach to a bottom edge of the kettle 22. In particular, the outer bolt retainer 26 includes two spaced apart side walls 50a and 50b and a bottom wall 52 extending between the side wall 50a, 50b such that the outer bolt retainer 26 is substantially “U” shaped and configured to slidably receive a bolt 30 in a notch 54 formed in the bottom wall 52 of the outer bolt retainer 26. The notch 54 is configured to receive a threaded shaft or shank portion of the bolt 30 while a head of the bolt 30 is configured to be located in a cavity 55 defined by the two side walls 50a and 50b and the bottom wall 52. In this way, the head of the bolt 30 is supported by the bottom wall 52. The side walls 50a and 50b and the bottom wall 52 are configured to be sized to receive the head of the bolt 30 and engage respective sides thereof such that it may not be rotated within the cavity 55 of the outer bolt retainer 26 while the bolt is mounted therein. The outer bolt retainer 26 is further configured with an arcuate kettle mating portion 56 provided on each of the side walls 50a and 50b that corresponds to the shape of a profile at the juncture of the side wall 23 and the bottom wall 24 of the kettle 22. As such, the kettle mating portion 56 on each of the side walls 502 and 50b may be welded to the kettle at the portion of the kettle where the side wall 23 and bottom wall 24 of the kettle 22 merge. FIG. 3B is a top view of the outer bolt retainer 26 further illustrating the notch 54 while FIG. 3C is a side view of the outer bolt retainer 26 further illustrating the arcuate kettle mating portion 56 on side wall 50a. As illustrated in FIGS. 3A-3C, at least a portion of the side walls 50a and 50b opposite the arcuate kettle mating portion 56 may be chamfered to reduce the cross-sectional area of the outer bolt retainer 26.

FIG. 4A is a bottom perspective view of an inner bolt retainer 28 according to one embodiment that is configured to receive a bolt 30 and attach to the bottom wall 24 of the kettle 22. Similarly to the outer bolt retainer 26, the inner bolt retainer 28 includes two spaced apart side walls 60a and 60b and a bottom wall 62 extending between the side walls 60a, 60b such that the inner bolt retainer 28 is substantially “U” shaped and configured to receive a bolt 30 in a notch 64 formed in the bottom wall 62 of the inner bolt retainer 28. Similarly to the notch 54 of FIGS. 3A-3C, the notch 64 of FIG. 4A is configured to slidably receive a threaded shaft or shank portion of the bolt 30 while a head of the bolt 30 is configured to be located in a cavity 65 defined by the two side walls 60a and 60b and the bottom wall 62. Similarly to the outer bolt retainer 26, the head of the bolt 30 is supported by the bottom wall 62. The side wall 60a and 60b and the bottom wall 62 are configured to be sized to receive the head of the bolt 30 and engage respective sides thereof such that it may not be rotated within the cavity 65 of the inner bolt retainer 28 while the bolt 30 is mounted therein. However, unlike the outer bolt retainer 26, the top of the inner bolt retainer 28 does not include an arcuate kettle mating portion 56 on each of the side walls 60a and 60b. Rather, the top of the side walls 60a and 60b of the inner bolt retainer 28 are substantially flat to provide a surface area with which to weld the inner bolt retainer 38 to the bottom wall 24 of the kettle 22. Correspondingly, FIG. 4B is a top view of the inner bolt retainer 28 further illustrating the notch 64 while FIG. 4C is a side view of the inner bolt retainer 28.

In some embodiments, the retainers 26 and/or 28 are cut from sheet metal about one-sixteenth of an inch thick and then bent into their respective shape as illustrated in FIGS. 3A-3C and 4A-4C.

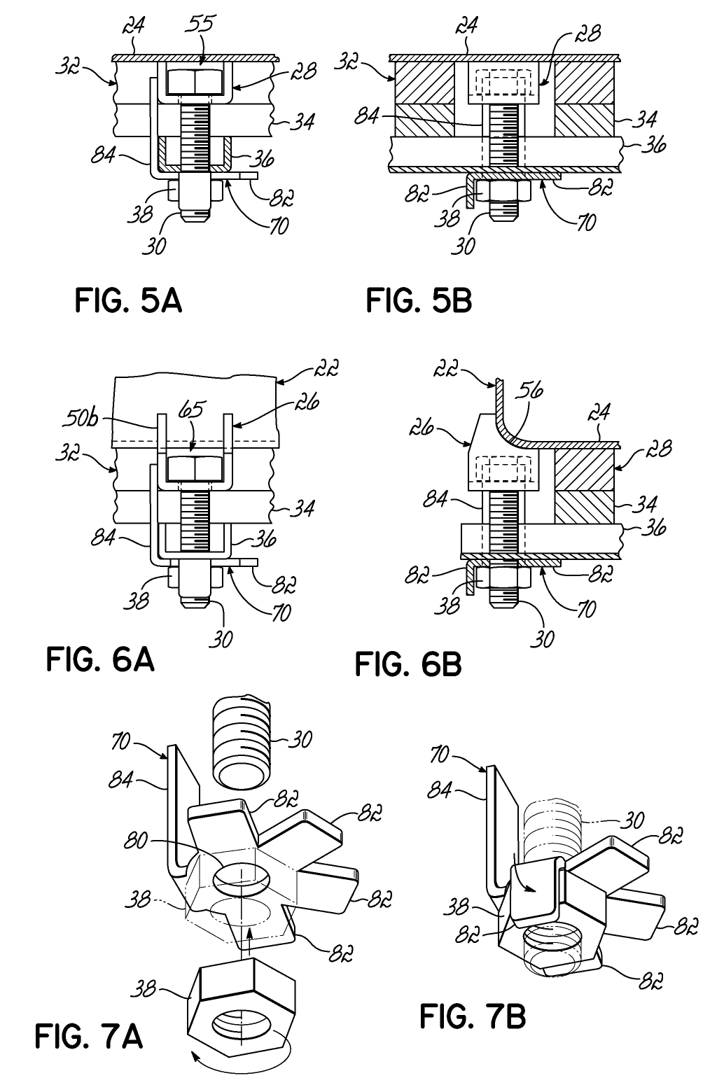

FIGS. 5A and 5B illustrate the interconnection of the bottom wall 24 of the kettle 22, the inner bolt retainer 28, the bolt 30, the heat transfer plate 32, the heating element 34, the retaining bar 36, the nut 38 and a nut retainer 70 that may be utilized to retain the nut 38 on the bolt 30. FIG. 5A illustrates that the inner bolt retainer 28 may be welded to the bottom wall 24 of the kettle 22. As such, the bolt 30 may be inserted into the notch 64 of the inner bolt retainer 28 so as to be removably supported thereby. In turn, the heat transfer plate 32 and heating element 34 may be mounted on the inner bolt retainer 28 and the bolt 30 and retained in place by the retaining bar 36. The retaining bar 36, in turn, may be retained in place by nuts 38 screwed onto the bolts 30. To prevent each nut 38 from slipping, the nut 38 may be retained in place by the nut retainer 70. Specifically, at least one side of the nut may contact the nut retainer 70 and thus be prevented from turning as described in detail below in connection with FIGS. 7A and 7B.

FIGS. 6A and 6B illustrate the interconnection of the bottom wall 24 of the kettle 22, the outer bolt retainer 26, the bolt 30, the heat transfer plate 32, the heating element 34, the retaining bar 36, the nut 38, and the nut retainer 70. FIG. 6B illustrates that the arcuate kettle mating portion 56 of each of the side walls 50a and 50b of the outer bolt retainer 26 may welded to the outer surface of the kettle 22 at the juncture of the side wall 23 and the bottom wall 24 of the kettle 22. As such, the bolt 30 may be inserted into the notch 54 of the outer bolt retainer 26 and so as to be removably supported thereby. In turn, the heat transfer plate 32 and heating element 34 may be configured to be retained in place by the retaining bar 36. The retaining bar 36, in turn, may be retained in place by the nuts 38 screwed onto the bolts 30. To prevent the nut 38 from slipping, the nut 28 may be retained in place by the nut retainer 70.

FIG. 7A and FIG. 7B illustrate the interconnection of the bolt 30, the nut retainer 70 and the nut 38. As illustrated in FIG. 7A, the nut retainer 70 may include an aperture 80 sized slightly larger than the threaded shank of the bolt 30. The nut retainer 70 includes a plurality of tabs 82 located about the aperture 80 that are configured to engage with the sides of the nut 38 when they are folded downwardly as shown in FIG. 7B. The nut retainer 70 also includes an elongated support tab 84 configured to engage with the retaining bar 36 and/or the bolt retainer 26 or 28 upon which the nut retainer 70 is mounted. The nut retainer 70 may be positioned around the bolt 30 such that the support tab 84 engages with the retaining bar 36 and/or the bolt retainer 26 and/or 28, and then the nut 38 may be placed around the bolt 30 and tightened. After tightening the nut 38 to provide a secure connection between the outer bolt retainer 26 and/or the inner bolt retainer 28, the bolt 30, the heat transfer plate 32, the heating element 34, the retaining bar 36 and/or the nut retainer 70, at least one of the tabs 82 of the nut retainer 70 may be bent or folded downwardly to engage with at least one side of the nut 38 as illustrated in FIG. 7B to prevent the nut 38 from moving. In this manner, the nut 38 is maintained in its position as any twisting motion of the nut 38 will be transferred by the tab 82 to the support tab 84, which in turn will be prevented from twisting due to its engagement with the retaining bar 36 and/or the bolt retainer 26 or 28. As illustrated in FIG. 7A and FIG. 7B, the nut retainer 70 includes four tabs 82. It will be appreciated that the nut retainer 70 may include more or fewer tabs 82, and that in some embodiments the nut retainer 70 includes only one tab 82.

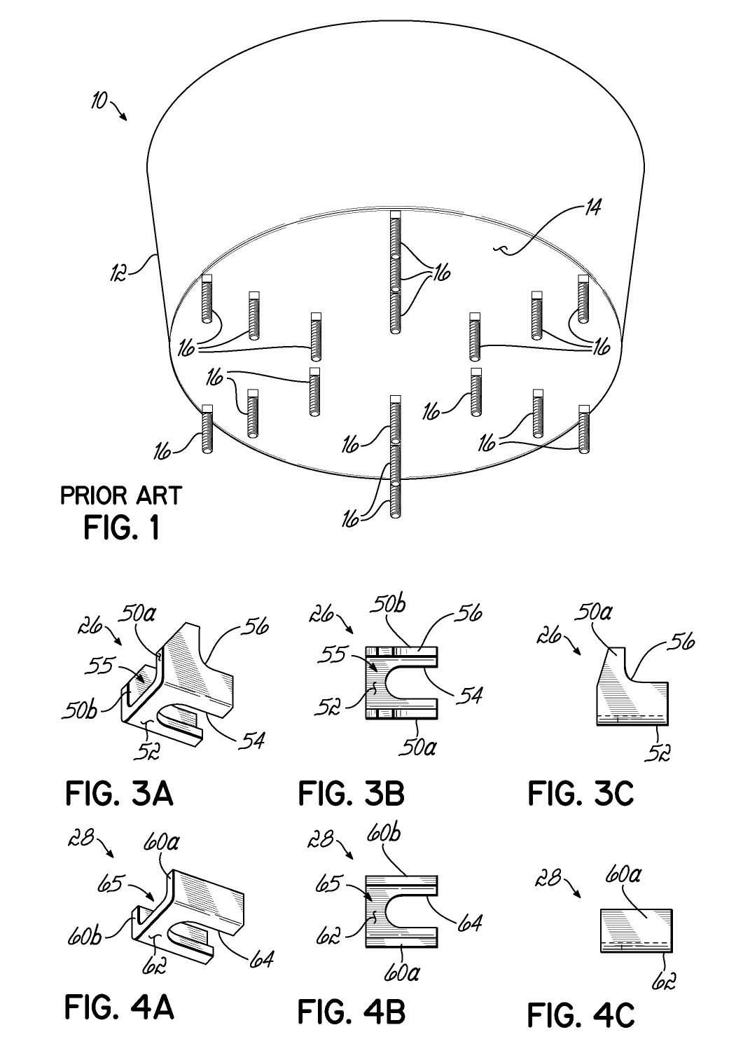

Those skilled in the art will recognize that the environments illustrated in FIGS. 1-7B are not intended to limit the present invention. Thus, while embodiments of the present invention have been illustrated by a description of the various embodiments and the examples, and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, representative apparatus shown and described. Accordingly, departures may be made from such details without departing from the spirit or scope of applicants' general inventive concept.

Other modifications will be apparent to one of ordinary skill in the art. Therefore, the invention lies in the claims hereinafter appended.

What is claimed is:

1. A bolt retainer for use in mounting a bolt having a head portion and a shank portion to a bottom wall of a popcorn popping kettle, comprising:
a pair of spaced apart side walls configured to be mounted to the bottom wall of the popcorn popping kettle;
a bottom wall extending between the pair of spaced apart side walls; and
a notch formed in the bottom wall,
the pair of spaced apart side walls and the bottom wall defining a cavity configured to receive the head portion of the bolt therein with the shank portion of the bolt extending through the notch in a direction away from the bottom wall of the kettle.

2. The bolt retainer of claim 1 wherein each of the side walls has an arcuate portion configured to be mounted to the bottom wall of the kettle.

3. The bolt retainer of claim 1 wherein each of the side walls has a generally flat portion configured to be mounted to the bottom wall of the kettle.

4. The bolt retainer of claim 1 wherein the bolt retainer is generally U-shaped.

5. The bolt retainer of claim 1 further comprising a bolt supported by the bolt retainer and a nut retained on the bolt.

6. A popcorn popping kettle assembly, comprising:
a popcorn popping kettle having an upstanding side wall and a bottom wall;
a plurality of bolt retainers mounted to the bottom wall of the kettle; and
a plurality of bolts each having a head portion and a shank portion slidably coupled with and supported by a respective one of the bolt retainers with the shank portions of the plurality of bolts extending in a direction away from the bottom wall of the kettle.

7. The popcorn popping kettle assembly of claim 6 wherein at least one of the bolt retainers comprises:
a pair of spaced apart side walls mounted to the bottom wall of the popcorn popping kettle;
a bottom wall extending between the pair of spaced apart side walls; and
a notch formed in the bottom wall,
the pair of spaced apart side walls and the bottom wall defining a cavity configured to receive the head portion of the bolt therein with the shank portion of the bolt extending through the notch.

8. The popcorn popping kettle assembly of claim 7 wherein the plurality of bolt retainers are mounted to the bottom wall of the kettle in a plurality of circumferentially spaced rows.

9. The popcorn popping kettle assembly of claim 8 further comprising a plurality of retaining bars each supported by a respective one of the plurality of circumferentially spaced rows of bolt retainers.

10. The popcorn popping kettle assembly of claim 9 further comprising at least one heating element disposed between the bottom wall of the kettle and the plurality of retaining bars.

11. The popcorn popping kettle assembly of claim 10 further comprising a heat transfer plate disposed between the bottom wall of the kettle and the at least one heating element.

12. The popcorn popping kettle assembly of claim 6 further comprising a nut retained on at least one of the bolts and a nut retainer configured to retain the nut on the at least one bolt.

13. A method of mounting a bolt having a head portion and a shank portion to a bottom wall of a popcorn popping kettle, comprising:
mounting a bolt retainer to the bottom wall of the kettle; and
slidably coupling the bolt with the bolt retainer so that the bolt is supported by the bolt retainer with the shank portion of the bolt extending in a direction away from the bottom wall of the kettle.

14. A method assembling a popcorn popping kettle, comprising:
obtaining a popcorn popping kettle having an upstanding side wall and a bottom wall;
mounting a plurality of bolt retainers to the bottom wall of the kettle; and
slidably coupling a plurality of bolts each having a head portion and a shank portion with a respective one of the plurality of bolt retainers so that the plurality of bolts are supported by the plurality of bolt retainers with the shank portion of each bolt extending in a direction away from the bottom wall of the kettle.

15. The method of claim 14 further comprising the step of:
mounting a heat transfer plate and at least one heating element to the bottom wall of the kettle using the plurality of bolts.
